(19) United States
(12) Patent Application Publication
(10) Pub. No.: US 2006/0003294 A1
(43) Pub. Date: Jan. 5, 2006

(54) Method for determining social timing

(76) Inventor: Paul D. O'Brien, Portland, OR (US)

Correspondence Address: PETER A. HAAS, ESQUIRE, 1929 SW 13TH AVENUE, PORTLAND, OR, 97201, US

(21) Appl. No.: 10/952,338

(22) Filed: Sep. 28, 2004

Related U.S. Application Data
(60) Provisional application No. 60/584,558, filed on Jul. 1, 2004.

(51) Int. Cl. G09B 19/00

(52) U.S. Cl. 434/106

(57) ABSTRACT

The present invention provides an astrosync heuristic including a method for determining social timing relative to any relationship between two people. Social timing refers to the advisability of an individual's interaction with another person and includes the changing levels of dynamic receptivity and dynamic assertiveness of each individual and the affect of this interaction at any given time. The present invention utilizes the fast-orbiting moon and its aspect with one or more natal planets to determine a person's recommended social timing and interaction style.

### PRIORITY CLAIM

This invention claims priority to provisional patent application entitled “A Method for Determining Personal Compatibility,” filed on 1 Jul. 2004 and having a Ser. No. 60/584,558.

### SCOPE OF INVENTION

This invention relates to a method for determining the social timing, including dynamic receptivity and dynamic assertivity, for one person or between multiple people using the aspects between the transiting moon and the planets, specifically Mars, Mercury, and Venus. Social timing transcends—and to a large part makes irrelevant—general “compatibility”. Instead this invention recognizes that each individual's ability to be receptive and assertive at any given time varies and offers a method to determine when and how an interaction between two individuals may be approached.

### BACKGROUND OF INVENTION

Mankind's fascination of the heavens pre-dates written history. Evidence of this fascination abounds and includes, for example, the astronomical temple of Stonehenge (circa 3200 B.C.), the descriptive astrology of ancient Mesopotamia (circa 5400 BC), and the equinoxically aligned pyramids of Egypt (circa 5400 B.C.). Peter Whitfield, Astrology: A History,” 7 (Harry N. Abrams, Inc. 2001).

Early study of the heavens germinated a belief that the planets circled the earth. To early civilizations the planets included the moon, the sun, Mercury, Venus, Mars, Saturn, and Jupiter—not surprising since each is visible by the naked eye.

Eventually, observations of the planetary positions (Mercury, Venus, Mars, Saturn, and Jupiter), the sun, and the moon became our first timepiece. For example, the sun and moon gave us day and night; the position of the sun in the daytime defined hours; each new-moon became a new month; and seasons were defined by the autumnal and vernal equinoxes and the summer and winter solstices. It is no surprise that the planting and harvesting of crops, religious observations, and other events correlate with the repetitive and predictable locations of the moon, sun, and other planets.

Astrology grew from these early observations of the planets, sun, and moon. Astrology began as measurement and plotting of the movements and positions the stars, planets, moon, and sun; it evolved in to the interpretation and prognostication of earthly events and personal characteristics and dispositions. Jim Tester, A History of Western Astrology, 11 (Boydell Press, 1987). The rudiments of modern astronomy are founded in astrology. In fact, distinction between astronomy and astrology can only be traced back to the seventh century A.D. Jim Tester, A History of Western Astrology, 19 (Boydell Press, 1987).

Astrology and astronomy intertwined throughout the majority of their existence. Only with the advancement of recorded history and improvements in mathematics did the study of the stars, planets, sun, and moon split to the empirical observations of astronomy and the art of prediction and influence of astrology. Despite this split, both astronomers and astrologers recognize the significance of the moon, which likely was the first celestial body to be accurately observed. Accurate tabulations of lunar observations are documented as early as 1800 B.C. Jim Tester, A History of Western Astrology, 11 (Boydell Press, 1987).

Astronomers promote the gravitational influence of the moon on the Earth. For example, the tidal patterns of the oceans are directly correlated to the position of the moon. This gravitational influence, moreover, is not limited to the fluid oceans—rather every object on the Earth reacts the moon's influence. The second daily high tide, for example, is a result of the attraction of Earth's landmasses to the moon.

The moon may have the greatest gravitational influence on the Earth, but it is not alone. For example, the sun has a tidal effect on the Earth despite being 391 times further away from the Earth as the moon. But, due to the sun's distance from the Earth, the sun's effect is about or 0.03 times the Moon's effect. Even distant Jupiter has a measurable gravitational effect on the Earth, about 0.01 times the moon's effect.

The moon's influence on the Earth is not limited to gravitational attraction. Traditional astrology, however, downplays the role of the moon as a prognosticator and influencer of earthly occurrences. Instead, the planets and the sun are believed to be the predominate influencers on the Earth. Traditional astrology teaches, for example, that a transiting Mercury influences communication and a transiting Mars is associated with decisive, definite, or assertive qualities in people. But, despite this downplay on the moon's influence some astrologers recognize that a transiting moon influences people's emotions and some will recognize that an individual's intuition and instinct are heightened at these times.

Other astrologers completely discount the influence of the moon. For example, according to Nina Lee Braden the transiting moon is not frequently used because it moves so rapidly. “[I]ts energy and its effect upon us is not as strong as the other planets, particularly the slower-moving outer planets. In astrology, the rule of thumb is, the slower moving the planet, the stronger the effect of the transit.” Nina Lee Braden, Astrology: The Transiting Moon, (visited Aug. 16, 2004) <http://www.geocities.com/Athens/Acropolis/2282/astro/moontran.htm.

Other astrologers cite an individual's Ruling planet as the most significant influencer. Astrology on the web: The planets and aspects, (visited on Aug. 10, 2004), <http://www.astrologycom.com/aspects.html/.

Traditional astrology has certain limits. For example, one limitation of relying on the slow-moving planets for prognostication of earthly events and personal characteristics and dispositions is the inherent imprecision of the transiting aspects of the planets relative to predicting dynamic interactions between people on a moment-by-moment basis. The measurable relative position of Jupiter from an observer's position on Earth right now and one hour from now is negligible and the change of its influence is equally negligible. An analogy to the tidal effect may be in order, the fast-moving moon dramatically influences the tides and the ocean level will perceptively change hour to hour. In contrast, the gravitational influence of Jupiter is only 0.01 times the moon's effect and its perceptive effect, therefore, is quite unnoticeable. The slow moving planets do have their use in determining general compatibility between individuals, but they are completely ill-suited to determine social timing between individuals—and cannot be used on a moment-to-moment basis.

Another limitation of the prior-art is the complexity of calculations required to determine the influence of the planets, sun, and moon to an individual. For example, U.S. Pat. No. 5,775,695 ('695 patent) teaches a method of evaluating a degree of attractiveness between a requesting player and a plurality of subject players. The disclosed method requires accumulation of selected demographic and astrological related data, termed “PersonalData”, which includes age, sex, sexual preference, date of birth, time of birth, and place of birth. A match using the PersonalData of the requesting player and the plurality of subject players is sought. This match is based on inserting the PersonalData into formulae based on the ecliptic position of the sun, moon, Mercury, Venus, Mars, Jupiter, Saturn, Uranus, ascendant midheaven, and north node—which yields a set of data for the requesting player. It is appreciated by those skilled in the art that the method of the '695 patent requires numerous, complex calculations of the position of several planets, stars, sun, and moon—among others—for a time period of interest. Moreover, it is appreciated that the time and location of a players birth is likely not known by the requesting player and, thus, the method of the '695 patent has limited use between a requesting player and subject players where such information is not available.

Another limitation of the prior-art is a focus on assessing general romantic compatibility between persons. In the prior-art this compatibility determination does not address the dynamic interaction between people. The dynamic interaction between people concerns the social timing and nature of communication—the “how” to communicate or interact and the “when” to initiate such communication. In short, the prior art is limited by its complexity and because it does not adequately address the “how” and “when” communication should begin between people. The prior-art also does not recognize that two people, even if they are general “incompatible” in the traditional sense, may need to interact. The prior-art, in failing to grasp this, does not, accordingly, address how such an interaction (the style or approach) should take place, nor doe the prior-art suggest when such an interaction should take place for optimal results.

Therefore, a need remains for a method to determine the social timing and interaction of one or more individual's dynamic receptivity and dynamic assertivity and their impact on their preferred communication styles and other interactions. Such a method should incorporate the profound influence of the moon on social timing as the moon changes position around the Earth. In addition, there is a need for a method that greatly reduces the computational complexity of determining aspects for each planet, sun, and moon relative to a specific location on the Earth. There is a need for a method that can dynamically predict the receptivity and varying levels of attraction and styles of interaction between two or more individuals. Finally, there is a need for a method that can suggest a time and manner (how and when) to interact with another person regardless of their general “compatibility” (as traditionally defined).

### SUMMARY OF THE INVENTION

The present invention incorporates the dynamic influence of the fast-orbiting moon to determine a person's recommended social timing. Social timing refers to the dynamic receptivity and dynamic assertiveness surrounding a person's ability to communicate or interact with another. For example, two people will each have a their own social timing value. The intersection of each person's social timing value is a good prognosticator of his or her ability to interact at a particular time with any other particular person. The social timing values ignore the general compatibility model and instead recognizes the affect of each persons ability to be receptive and assertive at a given time. The dynamic and fast-orbiting moon as an influencer on a person's receptivity and assertivity determines the social timing value of possible communication or other interactions.

The present invention contemplates a formula, termed an “astrosync heuristic”, that determines social timing using the birthdates of two people to calculate the positions of Venus, Mars, and Mercury at their respective births. The position of the planets on a person's birth date is termed the natal position of the planet. The natal positions of Venus, Mars, and Mercury are compared to the current position of the moon in the zodiacal sky to determine whether the resulting angle (also called an aspect) indicates a favorable, neutral, or challenging social timing quality value with respect to their natal Venus (capacity for receptivity and attraction), their natal Mars (capacity for outgoing assertiveness) and their natal Mercury (communication style).

This invention compares person-one's Mars Quality with person-two's Venus Quality to derive a numeric value from zero to five; a rating of five represents the most favorable and a rating of zero represents the most challenging to compatibility. This numeric value relates to an advisory sentence that describes the juxtaposition of person-one's Venus Quality and person-two's Mars Quality. The heuristic of the present invention makes a similar comparison between person-ones Venus Quality with person-two's Mars Quality, delivering a second numeric value plus another advisory sentence; and then again relative to person-one's Mercury Quality versus person-two's Mercury Quality.

Each Quality value ranges from zero to five and has an average value of 2.33. A relationship now total value is divided into three categories. The final result sums the numeric values from the three categories and determines the level of harmony. This result is represented, in part, by a pictorial representation of a common traffic light, for example. A sum of zero through four results in a red light, a sum of five through ten results in a yellow light, and a sum from eleven to fifteen results in a green light. The color of traffic light (green, yellow, or red) applies to the relationship at any moment in time (usually right now). The green light represents the most favorable condition possible and person-one is highly harmonious with person-two at the present time. The yellow light represents caution and the red light represents most challenging—suggesting that favorable interaction as measured by social timing is low right now.

The final result outputs the correspondingly colored light, three sentences, and person-two's name. The results should change several times per day, since the moon is the fastest moving orb in the sky and the angles will be changing constantly. In another embodiment, the present invention includes a method for determining social timing using the natal positions of the planets Mercury, Mars, and Venus. The method includes:
Providing a moon position;
Calculating a person-one moon-Mars aspect between person-one natal Mars and the moon position;
Calculating a person-one moon-Venus aspect between person-one natal Venus and the moon position;
Calculating a person-one moon-Mercury aspect between person-one natal Mercury and the moon position;
Correlating a person-one quality value for each moon-planet aspect resulting in a person-one Mars quality, a person-one Venus quality, and a person-one Mercury quality;
Calculating a person-two moon-planet aspect for reach of the three planets using the moon position and the natal position of each of the three plants for person-two and correlating a person-two moon-planet aspect resulting in a person-two Mars quality, a person-two Venus quality, and a person-two Mercury quality;
Crossing the person-one Venus quality with the person-two Mars quality to yield a first relationship-dynamic value;
Crossing the person-one Mars quality with the person-two Venus quality to yield a second relationship-dynamic value;
Crossing the person-one Mercury quality with the person-two Mercury quality to yield a third relationship-dynamic value; Providing a look-up table for the first, second, and third relationship-dynamic values;
Correlating an output from the look-up table to each respective first, second, and third relationship-dynamic values;
Providing a text-sentence corresponding to each respective first, second, and third relationship-dynamic values;
Outputting each respective text-sentence to provide a timing advisory assessment between person-one and person-two.

Summing the each respective first, second, and third relationship-dynamic values to result in a single relationship-now total value;
Correlating a color-coded output of red, yellow, or green to corresponding range of values for the relationship-now total value; and
Outputting the color-coded output in the form of a stop-go traffic light icon.

In yet another embodiment the present invention further contemplates:
Providing the current moon position based on a time now interval;
Providing a second moon position based on an future time interval; and
Applying the astrosync heuristic using the second moon position to determine a first, second, and third future-relationship dynamic value.

In another embodiment, the present invention includes the additional steps of outputting one or more text-sentences corresponding to each respective first, second, and third future-relationship dynamic value.

In another embodiment, the present invention includes outputting a color-coded icon for each respective first, second, and third future-relationship dynamic value.

In another embodiment, the present invention includes displaying a stop-go traffic light corresponding to each respective first, second, and third future-relationship wherein a red-light indicates a challenging future-relationship dynamic value and a yellow-light indicates a neutral future-relationship dynamic value and a green-light indicates a favorable future-relationship dynamic value.

### DRAWING

FIG. 1 illustrates a flow chart of the method of the present invention.

FIG. 2 illustrates a flow chart of an embodiment of FIG. 1.

FIG. 3 shows a table of the aspect chart of FIG. 2.

FIG. 4 shows a table of the sentence selector of FIG. 1.

FIG. 5 shows a table of representative sentence outputs of FIG. 1.

FIG. 6 illustrates a schematic diagram of a possible application of the present invention.

FIG. 7 shows one possible output format of the invention of FIG. 1.

### DESCRIPTION OF THE INVENTION

The present invention is illustrated by preferred embodiments, however, it is understood that the invention is not limited to the disclosed embodiments and is—on the contrary—intended to cover all alternatives, modifications, and equivalents as may be included in the spirit and scope of the invention as defined by the claims.

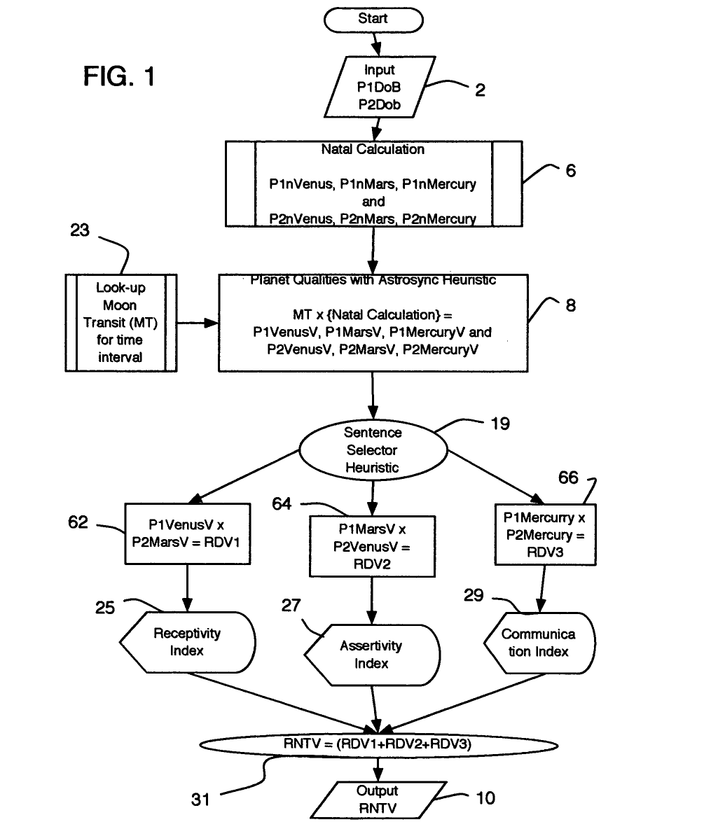

Making reference to FIGS. 1-7, wherein similar features share a common reference numeral, possible embodiments of the present invention are discussed.

Overview

The present invention simply and precisely determines the social timing of one or more people based on a set of astrological variables. Social timing refers to the dynamic receptivity and dynamic assertiveness surrounding a person's ability to communicate or interact with another. Social timing also refers to the appropriate way to communicate or interact (the “how-to”) and the appropriate time to (“when-to”) communicate or interact with another person.

The present invention includes a formula, termed an astrosync heuristic, and yields planet quality values based on calculating aspects between the transiting moon and the natal positions of Venus, Mars, and Mercury for a time period of interest. By comparing social timing values, or quality values, between a first person and a second person, for example, weighted relationship-dynamic values (RDVs) can be determined. The relationship-dynamic values prognosticate the receptivity, assertivity, and preferred style of communication or interaction between the two people. In one embodiment, specific text-sentences are output in relation to the various weighted relationship-dynamic values.

The present invention's primary function is to assess social timing including the dynamic receptivity and dynamic assertivity in a first person or between people. By determining social timing the present invention departs from traditional astrology as it is independent from general compatibility models. Furthermore, in traditional astrology the term “relationship” typically refers to a romantic interest by one person in another or between two people. The present invention incorporates a much broader definition of relationship, acknowledging that each person has many types of relationships in everyday life. For example, a person has a relationship with his or her boss, co-workers, neighbors, friends, spouse, hairdresser, agent, attorney, etc. Determining general compatibility between a person and such people does not address the important issue of whether—at a particular moment—such a person will be receptive to the interaction. Thus, another possible use of the present invention is to determine the social timing of an individual in real-time, taking into account the dynamics of a fast-orbiting moon and the associated influence of the fast-orbiting moon on the individual. In this manner, the present invention significantly departs from the prior-art by providing a means for assessing social timing between two people, independent of any romantic or affectionate aspects of their “relationship”.

The present invention utilizes transits of planets and the moon in a manner that significantly departs from methods of the prior-art. Unlike the prior-art, the present invention combines the effects of transiting planets on the natal charts of two people to reflect influences on the relationship between them at any particular time. The present invention advises how and when communication or interaction may be best approached.

Astrosync Heuristic—Basic Model

The present invention incorporates the discovery that the position of the fast-orbiting moon correlates to predictable traits in individuals on earth. This influence is captured by the present astrosync heuristic. The astrosync heuristic involves calculating the aspect between the transiting moon at a first time of interest and a position of a planet of interest at a second time of interest. In one embodiment the first time of interest is the current time and the second time of interest is a person's birth date. A person's birth date is used to calculate natal charts of the planets, for example. In another embodiment the first time of interest may consist of several future time periods, for example time=now, time=now +1 hour, time=now +2 hours, etc. In yet another embodiment the second time may be a time period other than the person's birthdate, but for simplicity, this disclosure will always refer to the second time of interest as a person's birthdate and thus may be readily related to standard natal charts of the planets, the prior-art being replete with examples of suitable planets, methods, and calculations for natal chart construction.

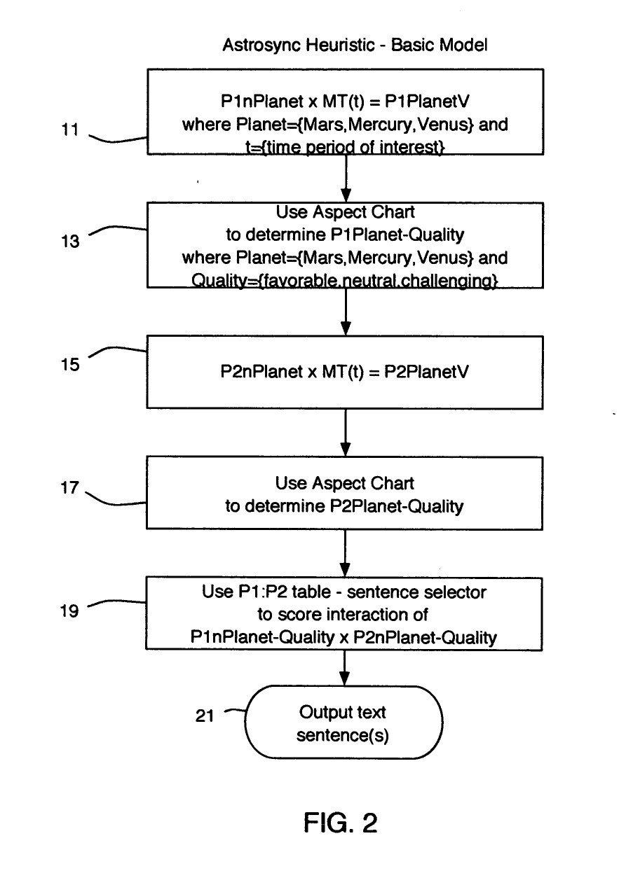

FIG. 2 illustrates the astrosync heuristic in basic form. The moon transit (MT) for a for time period of interest (t) is obtained by any means understood in the art, for example, the position for time (t) may be found in charts, tables, from the Internet, or calculated. According to the present invention, box 11 represents the calculation of the aspect between the moon transit at the first time of interest MT(t) and a first person's (P1) individualized natal chart for a selected planet of interest (P1nplanet), which yields a particular planet quality value (P1PlanetV). This expression is alternatively written as:
P1nPlanet×MT(t)=P1PlanetV.

Box 15 shows a similar calculation for a second person of interest (P2), which is illustrated as:
P2nPlanet×MT(t)=P2PlanetV.

Of note, the position of the transiting moon for a time period of interest is common to both person one and person two, as the interaction between individuals is assumed to take place at the same time. In other embodiments, however, the heuristic may be adapted to calculate the influence of the moon at two or more locations on the earth at the same time period (measured in standard hours, or GMT (Greenwich Mean Time)). Thus, interactions between two or more persons located in different time zones and different geographic locations may be used.

Generally, a natal chart includes positions for the Sun, Moon, Mercury, Mars, Venus, Saturn, Jupiter, Neptune, Uranus, and Pluto. However, in one embodiment of the present invention, the only the natal positions of Mars, Mercury, and Venus are used.

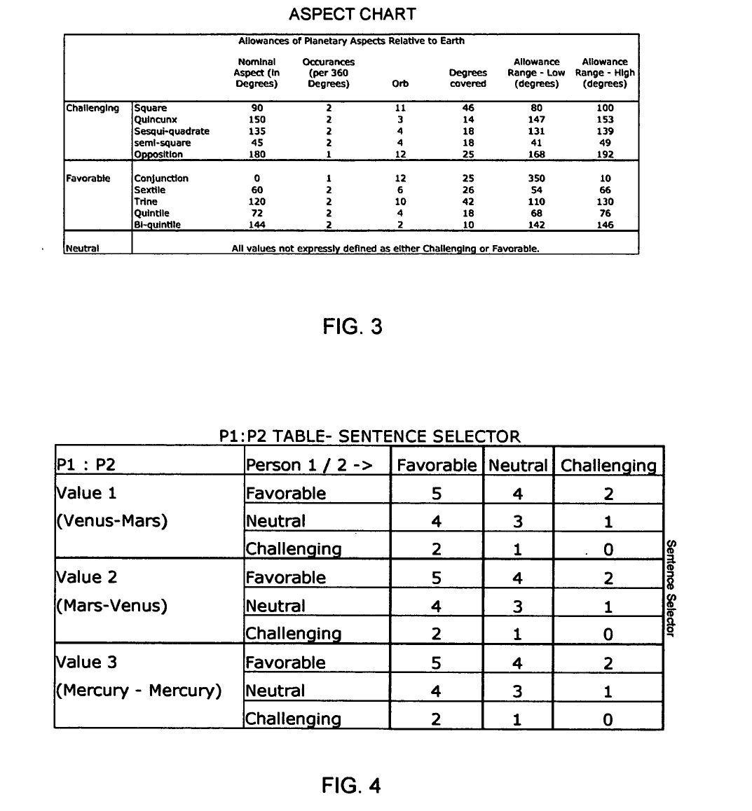

Box 13 shows the determination of the related planet-quality associated with the crossing of the moon transit, which is expressed as P1 PlanetV. Similarly, box 15 shows person two's related planet quality value. Thus, by crossing the transiting moon position for a time of interest (for example t=now) with the natal position of a planet (for example, Jupiter, Saturn, Mars, Venus Mercury, the Sun, or the Moon) the astrosync heuristic will associate a value for the resultant planet quality value. In one embodiment the value is qualitative, for example, challenging, neutral, or favorable, as shown in FIGS. 3 and 4. In another embodiment the resultant planet quality value may be a quantitative value, for example.

Astrosync Heuristic Applied to Moon-Planet Aspects

FIG. 1 illustrates one suitable application of the astrosync heuristic applied to planet-moon aspects and FIGS. 3-6 provide additional detail of the embodiment of FIG. 1. To facilitate discussion, the embodiment is discussed in four phases: Data Input, Calculations, Comparisons, and Output.

Data Input

The purpose of the data input stage is to gather detailed information from one or more people. This information is applied to the astrosync heuristic to customize a receptivity/assertivity analysis unique to the time of the interaction and the specific individuals interacting.

For example, person-one, perhaps a concerned adult, may wish to discuss an important health-care issue with her aging parent. It is important to understand how receptive the parent will be to this troubling subject, and equally important, it is necessary to understand the level of assertiveness in the concerned daughter. In this representative example, the compatibility between two people, person-one and person-two, is irrelevant. Rather, knowing how to communicate or interact and the levels of assertivity and receptivity in the individuals is of paramount importance.

It will be appreciated that more complex comparisons between two or more people may be attained by the methods described in this disclosure. In another example, the present invention contemplates analysis of social timing based on the data input of only one person.

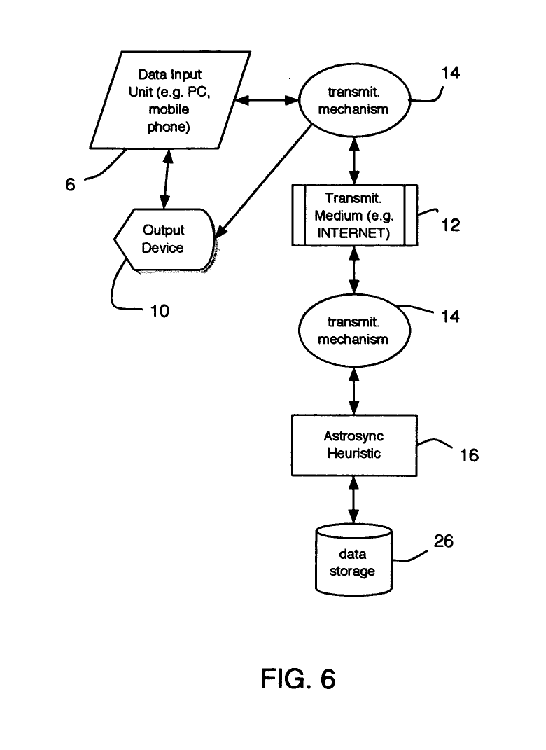

The input 2 of information may be done via the Internet 12 (shown in FIG. 6), over the telephone, via text messaging on a mobile or cellular-phone system, by in-person consultations, via facsimile, by mail, or other data exchange methods 14, for example. In one embodiment, the gathering of information is accomplished by an Internet link between person-one's personal computer, handheld device, mobile telephone, or similar data input device, which is in communication with a remotely located processing unit 16. In another embodiment the heuristic of the present invention is contained in an imbedded program wherein the data input unit 4, calculation unit 6, comparison unit 8, and output device 10 are all contained in a single apparatus.

FIG. 1 shows the data inputted 2 by person-one including person-one's date of birth (P1DoB) and person-two's date of birth (P2DoB). The current date (CD) is either inputted by person-one, or is provided by an internal clock and calendar heuristic provided by the remotely located processing unit 16 or provided by person-one's personal computer or similar data input device 6.

In another embodiment, additional information may be input. This information may be based on interactive questions that ascertain person-one's interests, hobbies, or objectives of the social timing report. For example, person-one may be interested in a romantic match with person-two. Alternatively, person-one may be interested in a business relationship with person-two, or friendship, or may already have a relationship and simply wishes to maximize the harmony between each person, for example. Accordingly, interactive questions can solicit person-one's ambitions and select output options that align more appropriately with the stated objective. For example, if person-one's interest was a business relationship with person-two, outputs that discussed romantic possibilities would be inappropriate.

Calculations.

Using the information gathered in the input phase 2, the calculation phase 6 calculates the natal positions of the planets for each person. The natal positions of the planets refer to the respective position of the planet on the birth date of the individual.

FIG. 3 lists quantitative values for the planet quality values based on the numeric calculation of the associated aspect. For example, if the aspect between the transiting moon at time (t) and natal Mars is 92-degrees, the table of FIG. 3 indicates the planet quality value to be “challenging.” In this example, 92-degrees falls within the range of 80-degrees to 100-degrees in the 7^{th and} 8^{th} column, respectively. It being understood that 92-degrees is proximate to a “square” in astrology aspects.

The aspect between the transiting moon and any planet is between 0-degrees and 360-degrees. The table of FIG. 3 divides the resultant aspects into three categories: “challenging,” “neutral,” and “favorable”. According to one embodiment of the invention the division illustrated in FIG. 3 provides about 121-degrees for “challenging” aspects, 121-degrees for “favorable” aspects, leaving about 118-degrees for “neutral” aspects. In other embodiments, the resultant aspects may be divided into more or less categories and with equal or unequal groupings of resulting degree-clusters.

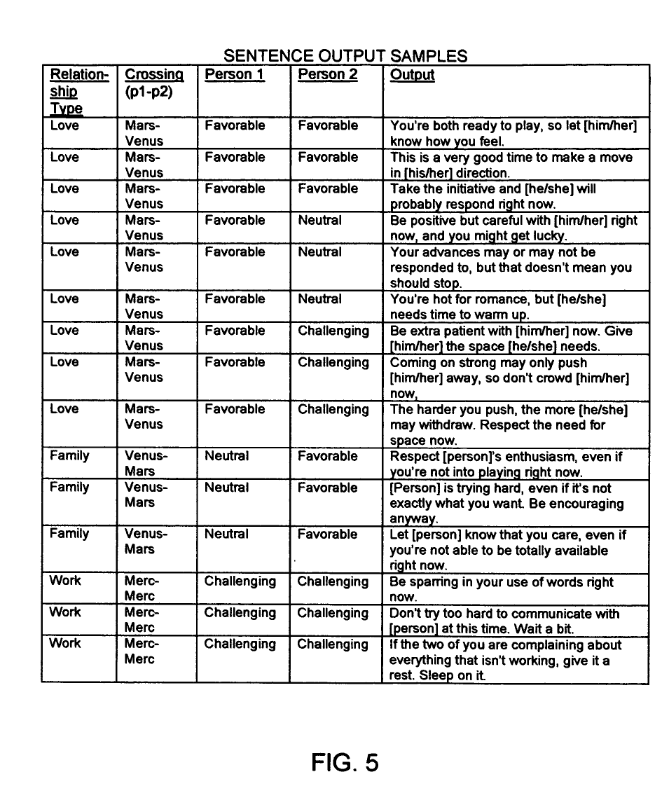

Box 19 of FIG. 1 shows the application of the sentence selector table of FIG. 4 to the basic astrosync heuristic. After obtaining a planet value for a first person P1PlanetV and a planet value for a second person P2PlanetV, the respective planet quality values are crossed according to the astrosync heuristic. In one embodiment, for example, person one's Venus value P1VenusV is crossed with person two's Mars value P2MarsV—however, it being understood than many combinations of planet values may be crossed. The sentence selector table of FIG. 4 facilitates the crossing of the planet values. The pairings of crossed planet quality values, in one embodiment results in the following combinations: favorable-favorable, favorable-neutral, favorable-challenging; neutral-favorable, neutral-neutral, neutral-challenging, challenging-favorable, challenging-neutral, and challenging-challenging. FIG. 4 shows that each pairing is giving a numerical rating. The numerical rating corresponds to a type of text sentence that is output. FIG. 5 illustrates some suitable examples of the types of text-sentences.

Mars—Mercury—Venus Model

In one embodiment, the natal positions of Venus, Mars, and Mercury are calculated for person-one and person-two using their respective date of birth (P1DoB or P2DoB). An individual's natal position of Venus corresponds to the capacity for receptivity and love, the natal position of Mars corresponds to the capacity of outgoing assertiveness, and the natal position of Mercury corresponds to the communication style.

FIG. 1 illustrates the resultant calculations 8 of Person-one's natal Venus (P1nVenus), natal Mars (P1nMars), and natal Mercury (P1nMercury). Similarly, person-two's natal Venus (P2nVenus), natal Mars (P2nMars), and natal Mercury (P2nMercury) are calculated.

Using the current date (CD), the current transit of the moon (MT) 23 is determined. The moon transit (MT) is expressed as an angle. The current moon transit (MT) is compared to the natal position of each planet, resulting in an angle termed the natal planet transit moon angle.

In one embodiment, the natal-planet transit-moon angle is calculated for each person of interest (person-one and person-two) for each planet of interest (Venus, Mars, and Mercury). In this embodiment the resultant calculations are defined as person-one's natal-Venus transit-moon angle, or, more simply, person-one's Venus value (P1VenusV). Similarly, the natal-Mars transit-moon angle and natal-Mercury transit-moon angle are termed Mars value (P1MarsVand Mercury value (P1MercuryV), respectively. Person-two also is assigned corresponding natal-planet transit-moon values based on person-two's birth date (P2DoB).

Person-one's Profile.

In one embodiment as illustrated by FIG. 2, for example, person-one's Venus value (P1VenusV) is compared to a look-up table, such as the table of FIG. 3, which may be incorporated into a software program, for example. Based on the calculated Venus value (P1VenusV), person-one receives a Venus Quality rating of “favorable”, “neutral”, or “challenging”, as represented by the table of FIG. 4. In the embodiment of FIG. 1, similar calculations are made for the Mars value (P1MarsV) and Mercury value (P1MercuryV) and results in a corresponding Mars Quality rating and Mercury Quality rating for person-one. Both the Mars Quality and Mercury Quality ratings are selected from the respective set of “favorable”, “neutral”, or “challenging.

Person-two's Profile.

In a contemplated embodiment of the present invention a second set of Quality ratings are calculated for person-two. Using the corresponding Venus value (P2VenusV), Mars value (P2MarsV), and Mercury value (P2MercuryV), person-two's profile receives a separate Venus Quality rating, Mars Quality rating, and Mercury Quality of “favorable”, “neutral”, or “challenging”.

Comparisons

In phase three the astrosync heuristic is applied to unique combinations of person-one Quality rating and person-two quality rating. Each crossing of person-one to person-two Quality ratings results in a relationship-dynamic value (RDV). Boxes 62, 64, and 66 of FIG. 1 represent the RDVs.

The first relationship-dynamic value (RDV1) 62 results from pairing person-one's Venus Quality rating with person-two's Mars Quality rating, or a Venus-Mars pairing. The Venus-Mars crossing, or pairing, is an indication of a person's receptivity. FIG. 1 shows the receptivity index 25 resulting from the Mars-Venus crossing. The second relationship-dynamic value (RDV2) 64 results from pairing person-one's Mars Quality rating with person-two's Venus Quality rating, or a Mars-Venus pairing. This results in a person's assertivity index 27. The third relationship-dynamic value (RDV3) 66 results from pairing person-one's Mercury Quality rating with person-two's Mercury Quality rating, or a Mercury-Mercury pairing, and is termed the communication index 29. Each index 25, 27, and 29 form the basis of the social timing value. Each relationship-dynamic value ranges from zero to five, with zero reflecting the most challenging condition and five reflecting the most positive. Each unique pairing has single value, which corresponds to one or more text sentences that describes the juxtaposition of person-one'one's Quality value to person-two's Quality value. FIG. 5 samples possible sentences resulting from the final output based on the Quality value comparison.

In an embodiment, phase three includes summing the individual relationship-dynamic values (RDV1+RDV2+RDV3) to get a Relationship Now Total Value (RTVN) 68. A second look-up table could be provided to define a color-code that corresponds to an overall compatibility rating for the unique interaction of person-one and person-two based on the current date (CD) 22.

Output

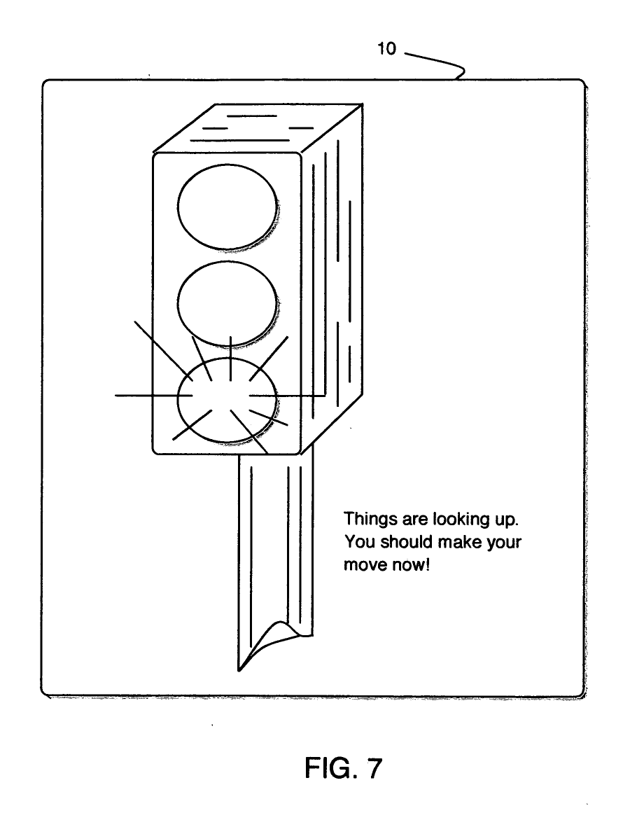

Phase four of the method of the present invention provides output from the previous three phases. In one embodiment, the output consists of a display to a monitor 10 or computer screen, for example. FIG. 7 illustrates one contemplated format for output 10 of an application of the astrosync heuristic. In FIG. 7, a green stop/go light indicates the favorable output concurrent with a sample text sentence.

Other output modes are contemplated. For example, the results could be reported orally (live voice, recorded message, or synthesized message, for example), making the invention useful for in-person consultations or telephone consultations. In another embodiment, the results are sent over a network 12, for example a mobile telephone network, in the form of text data for a sort of “instant” message to the recipient.

In one embodiment the relationship-dynamic values (RDV1, RDV2, and RDV3) each include three separate text sentences for each combination of person-one to person-two pairing. Each relationship-dynamic rating has eighteen permeations of text sentences. For example the first relationship-dynamic rating (RDV1)—the Venus-Mars pairing—comprises three possible outcomes (“favorable”, “neutral”, or “challenging) for person-one's Venus Quality and three possible outcomes for person-two's Mars Quality (“favorable”, “neutral”, or challenging), resulting in nine possible pairing. Each pairing has three unique text sentences, thus, a minimum of twenty-seven text sentences. In one embodiment at least 81 unique text sentences could be incorporated. Similarly, the second and third relationship-dynamic values, Mars-Venus and Mercury-Mercury pairings, respectively, have twenty-seven text sentences each. The combined total of text sentences, in this embodiment, is eighty-one unique sentences. FIG. 5 samples some contemplated sentences.

In alternative embodiments, text sentences may be added or subtracted from the matrix of outcomes. Further, the text sentences may be tailored based on responses gathered during the data input phase.

Although specific contemplated embodiments are described to illustrate the present invention, various modifications of the embodiments will be apparent to those having ordinary skill in the art.

I claim:

1. A method comprising:
providing a person-one natal position of a planet;
providing a position of the moon;
calculating a first aspect between the person-one natal position and the position of the moon;
providing an astrosync heuristic; and
correlating the first aspect using the formula to determine a person-one planet quality.

2. The method of claim 1 further comprising:
assigning one or more text sentences to correspond to the person-one planet quality.

3. The method of claim 1 further comprising:
outputting a color-coded icon corresponding to the person-one planet quality.

4. The method of claim 1 further comprising:
providing a person-one natal Mars position;
providing a person-one natal Venus position;
providing a person-one natal Mercury position;
calculating the person-one first aspects for each respective natal Mars, natal Venus, and natal Mercury positions;
using the astrosync heuristic to correlate the person-one Mars aspect to a person-one Mars quality;
using the astrosync heuristic to correlate the person-one Venus aspect to a person-one Venus quality; and
using the astrosync heuristic to correlate the person-one Mercury aspect to a person-one Mercury quality.

5. The method of claim 1 further comprising:
providing a person-two natal position of a planet;
calculating a second aspect between the person-two natal position and the position of the moon;
using the formula to correlate the person-two second aspect to a person-two planet quality.

6. The method of claim 4 further comprising:
providing a person-two natal Mars position;
providing a person-two natal Venus position;
providing a person-two natal Mercury position;
calculating the person-two aspects for each respective natal Mars, natal Venus, and natal Mercury positions;
using the astrosync heuristic to correlate the person-two Mars aspect to a person-two Mars quality;
using the astrosync heuristic to correlate the person-two Venus aspect to a person-two Venus quality; and
using the astrosync heuristic to correlate the person-two Mercury aspect to a person-two Mercury quality.

7. The method of claim 6 further comprising:
crossing the person-one Mars quality with the person-two Venus quality resulting in a first value;
crossing the person-one Venus quality with the person-two Mars quality resulting in a second value; and
crossing the person-one Mercury quality with the person-two Mercury quality resulting in a third value.

8. The method of claim 7 further comprising:
summing the first value, the second value, and the third value resulting in a relationship-now total value.

9. The method of claim 8 further comprising:
correlating the total relationship-now value to a color-coded output representing a favorable, challenging, or neutral social timing factor between the person-one and the person-two.

10. The method of claim 9 further comprising:
selecting at least one text-sentence based on the total relationship-now value; and
displaying the at least one text-sentence.

11. The method of claim 7 further comprising:
outputting at least one text-sentence correlating to the each respective first value, second value, and third value.

12. A method for determining social timing comprising:
providing a first natal-Mars position, a first natal-Mercury position, and a first natal-Venus position for a person-one;
providing a second natal-Mars position, a second natal-Mercury position, and a second natal-Venus position for a person-two;
providing at least one moon-transiting position for a time interval of interest;
determining a first natal-Mars-Moon aspect, a first natal-Mercury-Moon aspect, and a first natal-Venus-Moon aspect for person-one; and
determining a second natal-Mars-Moon aspect, a second natal-Mercury-Moon aspect, and a second natal-Venus-Moon aspect for person-two.

13. The method of claim 12 further comprising:
providing an astrosync heuristic;
determining a first value using the astrosync heuristic and based on a crossing between the first natal-Mars-Moon aspect and the second natal-Venus-Moon aspect;
determining a second value using the formula and based on a crossing between the first natal-Venus-Moon aspect and the second natal-Mars-Moon aspect;
determining a third value using the formula and based on crossing the first natal-Mercury-Moon aspect and the second natal-Mercury-Moon aspect; and
summing the first value, the second value, and the third value resulting in a total relationship-now value.

14. The method of claim 13 further comprising:
outputting a red-colored stop-go light corresponding to a challenging score for the total relationship-now value;
outputting a yellow-colored stop-go light corresponding to a neutral score for the total relationship-now value;
outputting a green-colored stop-go light corresponding to a favorable score for the total relationship-now value.

15. The method of claim 13 further comprising:
outputting a first text-sentence corresponding to the first value;
outputting a second text-sentence corresponding to the second value; and
outputting a third text-sentence corresponding to the third value.

16. A method for determining social timing using the natal positions of the planets Mercury, Mars, and Venus, the method comprising:
providing a moon position;
calculating a person-one moon-Mars aspect between person-one natal Mars and the moon position;
calculating a person-one moon-Venus aspect between person-one natal Venus and the moon position;
calculating a person-one moon-Mercury aspect between person-one natal Mercury and the moon position;
correlating a person-one quality value for each moon-planet aspect resulting in a person-one Mars quality, a person-one Venus quality, and a person-one Mercury quality;
calculating a person-two moon-planet aspect for reach of the three planets using the moon position and the natal position of each of the three plants for person-two and correlating a person-two moon-planet aspect resulting in a person-two Mars quality, a person-two Venus quality, and a person-two Mercury quality;
crossing the person-one Venus quality with the person-two Mars quality to yield a first relationship-dynamic value;
crossing the person-one Mars quality with the person-two Venus quality to yield a second relationship-dynamic value;
crossing the person-one Mercury quality with the person-two Mercury quality to yield a third relationship-dynamic value;
providing a look-up table for the first, second, and third relationship-dynamic values;
correlating an output from the look-up table to each respective first, second, and third relationship-dynamic values;
providing a text-sentence corresponding to each respective first, second, and third relationship-dynamic values;
outputting each respective text-sentence to provide a timing advisory assessment between person-one and person-two.
summing the each respective first, second, and third relationship-dynamic values to result in a single relationship-now total value;
correlating a color-coded output of red, yellow, or green to corresponding range of values for the relationship-now total value; and
outputting the color-coded output in the form of a stop-go traffic light icon.

17. The method of claim 16 further comprising:
providing the current moon position based on a time now interval;
providing a second moon position based on an future time interval; and
applying the astrosync heuristic using the second moon position to determine a first, second, and third future-relationship dynamic value.

18. The method of claim 17 further comprising:
outputting one or more text-sentences corresponding to each respective first, second, and third future-relationship dynamic value.

19. The method of claim 17 further comprising:
outputting a color-coded icon for each respective first, second, and third future-relationship dynamic value.

20. The method of claim 17 further comprising:
Displaying a stop-go traffic light corresponding to each respective first, second, and third future-relationship wherein a red light indicates a challenging future-relationship dynamic value and a yellow-light indicates a neutral future-relationship dynamic value and a green light indicates a favorable future-relationship dynamic value.
